(19) United States
(12) Patent Application Publication
(10) Pub. No.: US 2025/0087955 A1
(43) Pub. Date: Mar. 13, 2025

(54) ALIGNMENT COMB FOR CONNECTOR CONTACTS

(71) Applicant: Hamilton Sundstrand Corporation, Charlotte, NC (US)

(72) Inventors: Catherine Canciamille, Rockford, IL (US); Kevin Kilroy, Gilberts, IL (US)

(73) Assignee: Hamilton Sundstrand Corporation, Charlotte, NC (US)

(21) Appl. No.: 18/367,419

(22) Filed: Sep. 12, 2023

(51) Int. Cl. H01R 43/20; H01R 12/71

(52) U.S. Cl. CPC H01R 43/205; H01R 12/716

(57) ABSTRACT

In accordance with at least one aspect of this disclosure, a system includes, an alignment comb configured to prevent rotation of a contact pin of a connector relative to the connector. In embodiments, the alignment comb can be of a non-electrically conductive material. In embodiments, the alignment comb includes, a planar portion extending along a longitudinal axis between a first end and a second end, an aperture defined in the planar portion, and a slot defined at least partially within the planar portion. Embodiments of the slots within the alignment comb allow the comb to slide along the first and second respective contact pins such that the alignment comb can be lifted to allow for application of a conformal coating on the contact pins and/or to allow soldering the contact pins to a printed wiring board.

### TECHNICAL FIELD

The present disclosure relates connectors and more particularly to combs for aligning connector contacts.

### BACKGROUND

Conventional connectors can include solder tail contacts, which can have a right-angle. These contacts can rotate even if a small force is applied, which can cause the tails to be misaligned when trying to install the connector onto a printed wiring board. An alignment comb is often needed to keep the contacts from rotating until they are soldered in place. Typical alignment combs can sit low on the board which can inhibit coating coverage and inspection in the area. These conventional combs are not removeable and cannot be raised for more access to the solder joints, for example, as the comb is restricted by the bend radius of the shortest contact.

The conventional techniques have been considered satisfactory for their intended purpose. However, there is an ever present need for improved alignment combs for connector contact pins. This disclosure provides a solution for this need.

### SUMMARY

In accordance with at least one aspect of this disclosure, a system includes, an alignment comb configured to prevent rotation of a contact pin of a connector relative to the connector. In embodiments, the alignment comb can be of a non-electrically conductive material. In embodiments, the alignment comb includes, a planar portion extending along a longitudinal axis between a first end and a second end, an aperture defined in the planar portion, and a slot defined at least partially within the planar portion. The slot is defined between a first finger and a second finger. A first portion of each finger is co-planar with the planar portion and a second portion of each finger is out of plane with the planar portion.

The aperture is configured to receive a first respective contact pin therein to retain the first respective contact pin within the aperture and the slot is configured to receive a second respective contact pin therein to retain the second respective contact pin within the slot. The alignment comb is configured to slide along the first and second respective contact pins, e.g., when seated thereon.

In embodiments, the alignment comb can include a plurality of apertures defined in the planar portion along the axial length of the alignment comb between the first end and the second end. In certain embodiments, the plurality of apertures can form a first row of apertures defined in the planar portion, and the plurality of apertures can further include a second row of apertures. In certain embodiments, one aperture of the first row of apertures or the second row of apertures can be axially aligned with the slot across a width of the planar portion. In certain embodiments, one aperture of the first row of apertures or the second row of apertures is axially offset from the slot across a width of the planar portion.

In embodiments, the alignment comb can include a plurality of slots defined between respective fingers, each slot being at least partially within the planar portion. The plurality of slots can be axially aligned with the plurality of apertures. In certain embodiments, the plurality of slots can be axially offset from the plurality of apertures. In certain embodiments, the plurality of slots includes a first group of slots and a second group of slots. In certain embodiments, the second group of slots can extend farther into the planar portion than the first group of slots. In certain embodiments, the first group of slots can be axially aligned with the plurality of apertures and the second group of slots. In certain embodiments, the second group of slots can be axially offset from the plurality of apertures and the first group of slots (e.g., the first group and the second group of slots alternate along the length of the planar portion in the axial direction).

In embodiments, the system can include the connector. The connector can include the first respective contact pin and the second respective contact pin, where each of the first and second contact pins extend outward from the connector in a first direction to a corner and extend from the corner downward in a second direction perpendicular to the first direction to a free end. The free end of the first respective contact pin is disposed in the aperture, and the free end of the second respective contact pin is disposed in the slot.

In embodiments, the connector includes a plurality of contact pins, extending from the connector. The first respective contact pin can be defined in a first row of contact pins and the second respective contact pin can be defined in a second row of contact pins. The free end of each contact pin of the first row of contact pins can be disposed in a respective aperture of the plurality of apertures and the free end of each contact pin of the second row of contact pins can be disposed in a respective slot of the plurality of slots.

In embodiments, the plurality of contact pins of the connector can further include a third row of contact pins. In certain embodiments, the third row of contact pins can be axially offset from the first row of contact pins and the second row of contact pins. The third row of contact pins can be between the first row of contact pins and the second row of contact pins. In certain embodiments, the free end of each contact pin of the third row of contact pins can be disposed in a respective aperture of a second row of apertures. In certain such embodiments, the alignment comb can be configured to slide along the contact pins up to the corner of the third row of contact pins. Here, the corner of the third row of contact pins is higher than the corner portion of the second row of contact pins to allow for application of a conformal coating on the contact pins and/or to allow soldering the contact pins to a printed wiring board, and/or to allow inspection of complete solder joints.

In certain embodiments, the free end of each contact pin of the third row of contact pins is disposed in a respective slot of the second row of slots. In certain such embodiments, the alignment comb can be configured to slide along the contact pins up to the corner of the first row of contact pins. Here the corner of the first row of contact pins is higher than the corner of the third row of contact pins to allow for better application of the conformal coating on the contact pins and/or to allow soldering the contact pins to a printed wiring board and/or to allow for inspection of complete solder joints.

In accordance with at least one aspect of this disclosure, a system can include a printed wiring board, a connector having a plurality of contact pins configured to be soldered to the printed wiring board, and an alignment comb configured to prevent rotation of the free end of the contact pin relative to the connector.

In embodiments, the plurality of pins of the connector can include, a first row of contact pins, a second row of contact pins, and a third row of contact pins. Each contact pin of the first row, the second row, and the third row, can extend outward from the connector in a first direction to a corner and extend away from the corner in a second direction perpendicular to the first direction to a free end of the contact pin. In embodiments, the contact pins of the first row can be longer than the contact pins of the second row and the contact pins of the third row can be longer than the contact pins of the second row and can be shorter than the contact pins of the first row. In embodiments, each row of contact pins can be axially aligned with one another, or one or more rows of contact pins can be axially offset from one another.

In embodiments, the alignment comb can include, a first row of retaining features configured to retain the contact pins of the first row, a second row of retaining features configured to retain the contact pins of the second row, a third row of retaining features configured to retain the third row of contact pins. In embodiments, the first row of retaining features can include a plurality of apertures and each contact pin of the first row of contact pins can be disposed in a respective aperture of the plurality of apertures. The second row of retaining features can include a plurality of slots defined between a first finger and a second finger and each contact pin of the second row of contact pins can be disposed in a respective each slot of the plurality of slots. Each contact pin of the third row can be disposed a respective retaining feature of the third row of retaining features.

In certain embodiments, the third row of retaining features can include a plurality of apertures defining a second row of apertures. Each contact pin of the third row of contact pins can be disposed in a respective aperture of the second row of apertures.

In certain embodiments, the third row of retaining features can include a plurality slots defined between respective fingers of a plurality of fingers and in a second group of slots. The second group of slot can extend farther into the a body of the alignment comb than the first group of slots. In certain embodiments, the first group of slots can be axially aligned with the plurality of apertures and the second group of slots can be axially offset from the plurality of apertures and the first group of slots. In embodiments, a first portion of each finger can be co-planar with the body of the alignment comb and a second portion of each finger can be out of plane with the body of the alignment comb.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, other embodiments thereof will be described in detail herein below with reference to certain figures, wherein:

FIG. 1 is a perspective view of a connector, showing a plurality of contact pins extending from the connector;

FIG. 2 is a side view of the connector of FIG. 1, showing the contact pins retained within an alignment comb;

FIG. 3 is a rear perspective view of the connector of FIG. 1, showing the contact pins retained within the alignment comb of FIG. 2,

FIG. 4 is a side elevation view of the contact pins retained within the alignment comb of FIG. 2;

FIG. 5 is a perspective view of the alignment comb of FIG. 4 showing an insertion of the contact pins into respective retaining features;

FIG. 6 is a side elevation view of the contact pins retained within another embodiment of an alignment comb;

FIG. 7 is a perspective view of the alignment comb of FIG. 6;

FIG. 8 is a perspective view of another embodiment of an alignment comb; and

FIG. 9 is a perspective view of another embodiment of an alignment comb.

### DETAILED DESCRIPTION

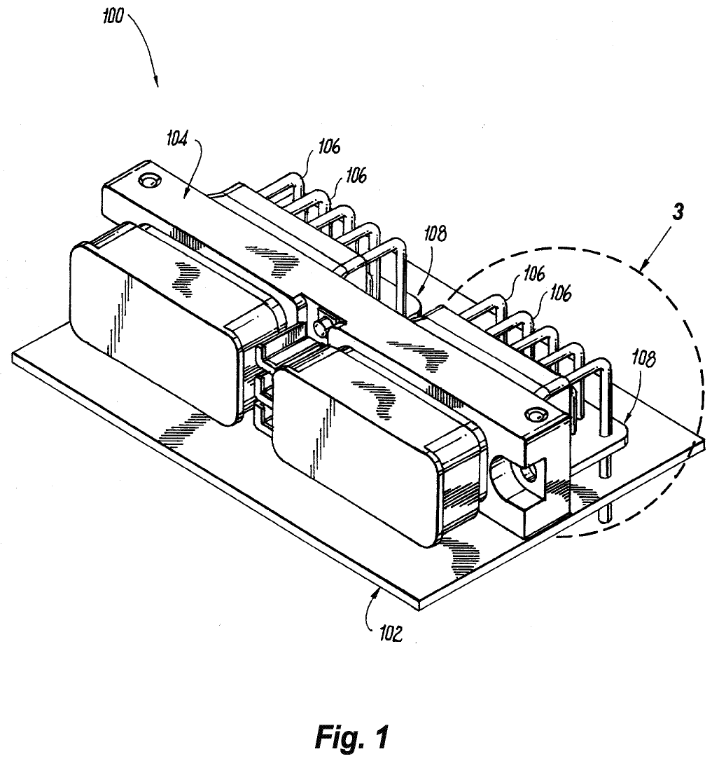

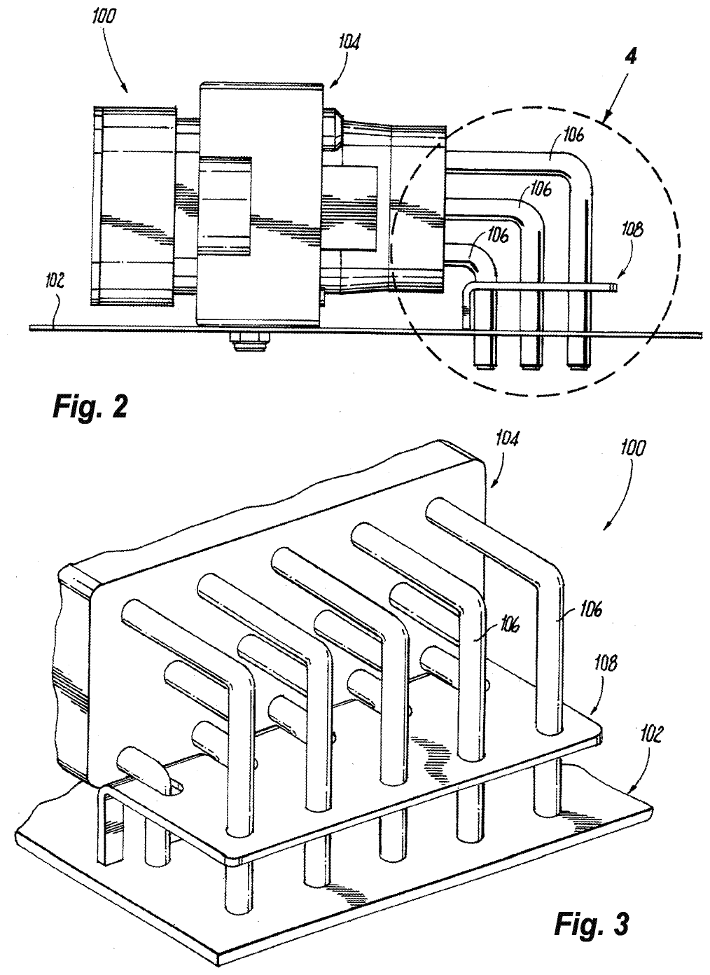

Reference will now be made to the drawings wherein like reference numerals identify similar structural features or aspects of the subject disclosure. For purposes of explanation and illustration, and not limitation, an illustrative view of an embodiment of a system in accordance with the disclosure is shown in FIG. 1 and is designated generally by reference character 100. Other embodiments and/or aspects of this disclosure are shown in FIGS. 2-9.

In accordance with at least one aspect of this disclosure, as shown in FIGS. 1-3, a system 100 can include a printed wiring board 102, a connector 104 having a plurality of contact pins 106 configured to be soldered to the printed wiring board 102, and an alignment comb 108 configured to prevent rotation of a free end 110 of the contact pins 106 relative to the connector 104. In embodiments, the alignment comb 108 can be made of a non-electrically conductive material. In embodiments, the non-electrically conductive material can be non-metallic.

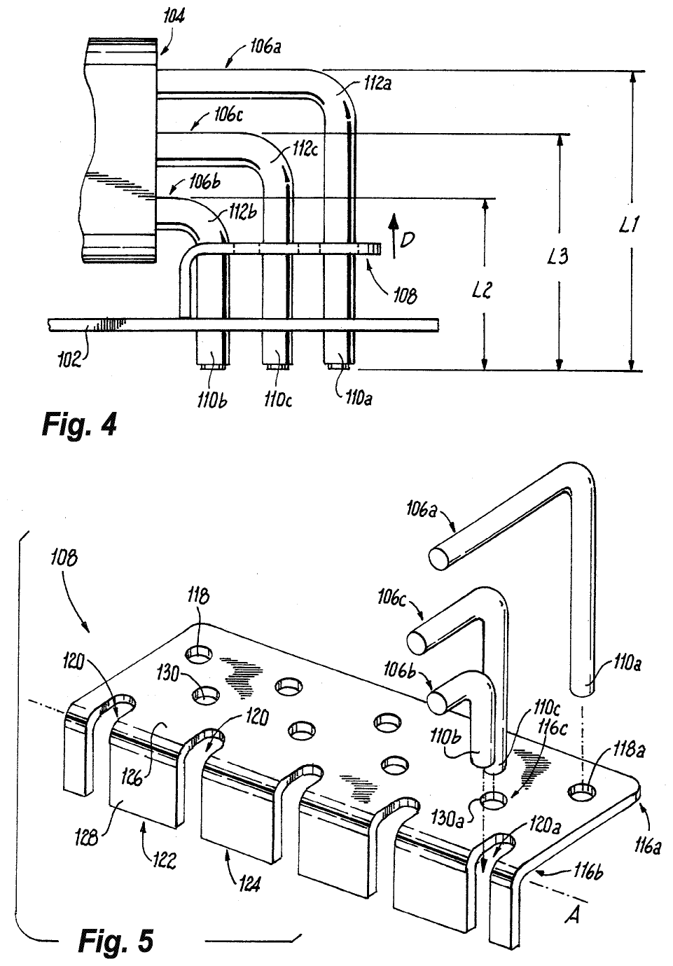

In embodiments, the plurality of pins 106 of the connector 104 can include, a first row of contact pins 106a, a second row of contact pins 106b axially aligned with the first row of contact pins 106a, and a third row of contact pins 106c axially offset from the first row of contact pins 106a and the second row of contact pins 106b. Each contact pin 106 of the first row, the second row, and the third row, can extend outward from the connector 104 (e.g., outward from a main body of the connector 104) in a first direction to a corner 112a, b, c and extend away from the corner 112a, b, c in a second direction perpendicular to the first direction to the free end 110a, b, c of the contact pin 106a, b, c. In embodiments, the contact pins of the first row 106a can be longer than the contact pins of the second row 106b and the contact pins of the third row 106c can be longer than the contact pins of the second row 106b and can be shorter than the contact pins of the first row 106a, such that L1>L3>L2 (e.g., as best seen in FIG. 4).

Referring now to FIGS. 4-7, in embodiments, the alignment comb 108 can include a planar body 114 having therein: a first row of retaining features 116a configured to retain the contact pins of the first row 106a, a second row of retaining features 116b configured to retain the contact pins of the second row 106b, a third row of retaining features 116c configured to retain the third row of contact pins 106c. The first row of retaining features 116a can include a plurality of apertures 118 and each contact pin of the first row of contact pins 106a can be disposed in a respective aperture 118a of the plurality of apertures 118. The second row of retaining features 116b can include a plurality of slots 120 defined between a first finger 122 and a second finger 124 and each contact pin of the second row of contact pins 106b can be disposed in a respective slot 120a of the plurality of slots 120. In embodiments, a first portion 126 of each finger (e.g., as shown with respect to finger 122) can be co-planar with the body 114 of the alignment comb 108 and a second portion 128 of each finger 122 can be out of plane with the body 114 of the alignment comb 108 (e.g., perpendicular as shown).

With specific reference now to FIGS. 4 and 5, in certain embodiments, the third row of retaining features 116c can include a plurality of apertures 130 defining a second row of apertures axially offset from the first row of apertures 118 and axially offset from the slots 120. Each contact pin of the third row of contact pins 106c can be disposed in a respective aperture 130a of the second row of apertures 130.

In certain such embodiments, the alignment comb 108 can be configured to slide along the contact pins 106 (e.g., along direction D) up to the corner 112c of the third row of contact pins 106c. Here, the corner 112c of the third row of contact pins 106c represents a height limit of how high the comb 108 can be lifted off the board 108. This is due to the corner 112c of the contact pin 106c physically impeding movement of the aperture 130c beyond the corner 112c. The height L3 of the third row of contact pins 106c is greater than height L2 of the second row of contact pins, thus, the alignment comb 108 can be lifted higher up off the board 102 than if the second row of contact pins 106b were seated in an aperture since the slot 120a allows for the comb 108 to be raised above the corner 112b and up to the corner 112c. The ability to raise the alignment comb 108 off the board 102 allows for easier and more consistent application of a conformal coating on the contact pins 106 and/or to allow soldering the contact pins 106 to the printed wiring board 102, and/or to allow for inspection of complete solder joints.

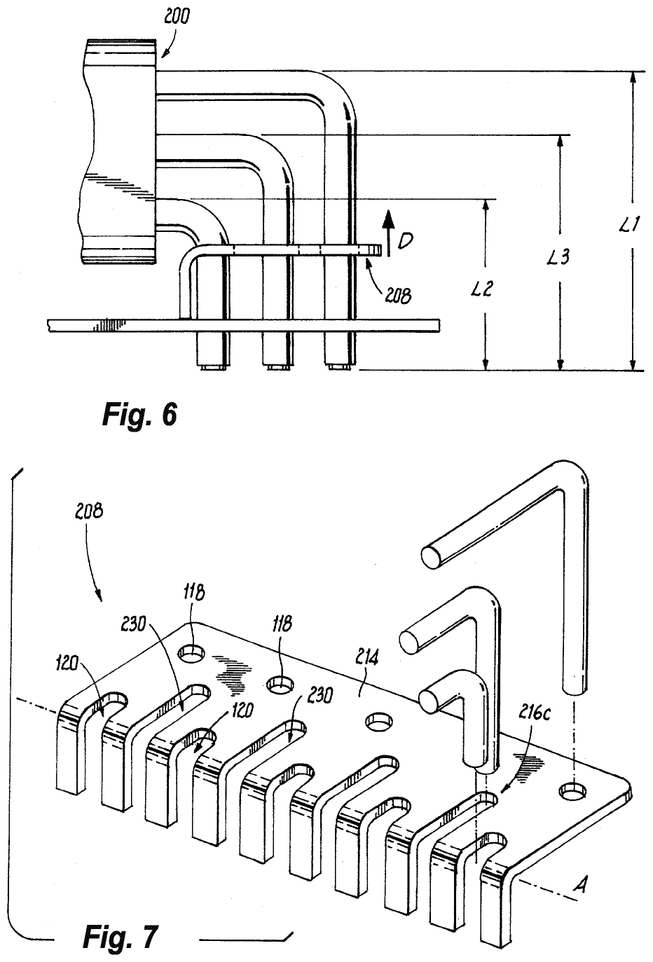

With reference now to FIGS. 6 and 7, in certain embodiments, an embodiment of an alignment comb 208 is shown for a system 200. The third row of retaining features 216c can include a plurality of slots 230 in a second group of slots, where the slots 120 are a first group of slots. The second group of slots 230 can extend farther into the body 214 of the alignment comb 208 than the first group of slots 120. As shown, the first group of slots 120 can be axially aligned with the plurality of apertures 118 and the second group of slots 230 can be axially offset from the plurality of apertures 118 and the first group of slots 120. Here, the alignment comb 208 can be configured to slide along the contact pins 106 (e.g., along direction D) up to the corner 112a of the first row of contact pins 106a. This allows the comb 208 to be lifted higher off of the board 102 than the comb 108, for example.

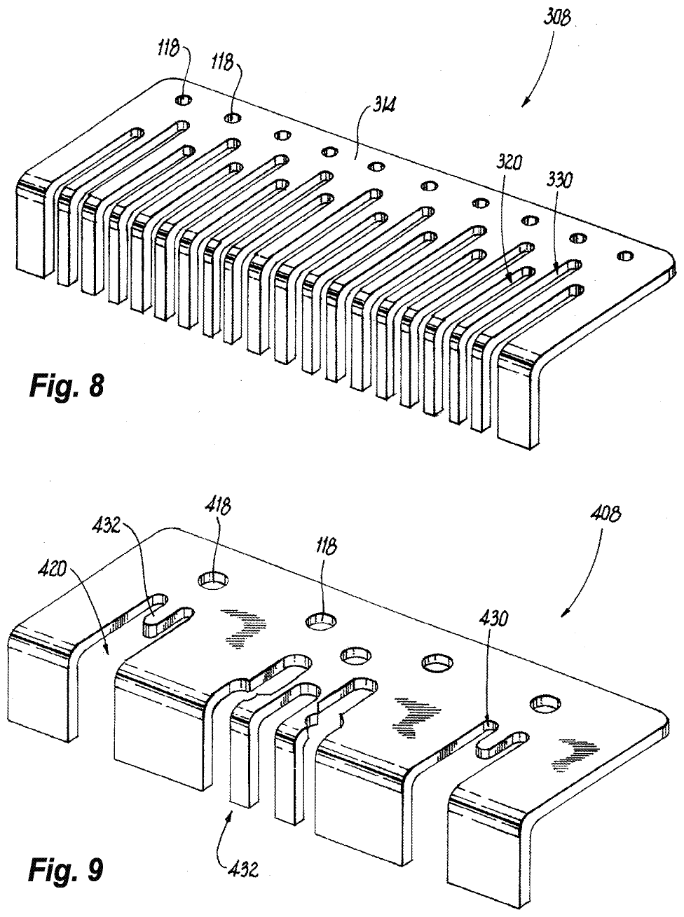

While FIGS. 1-7 are described with reference to a connector having three rows of contact pins 106, the first and second rows axially aligned, and the third row axially offset from the first and second rows, the retaining features of the alignment comb 108, 208 can be arranged in any suitable manner to accommodate the arrangement of the contact pins of a given connector. For example, FIG. 8 shows an embodiment of an alignment comb 308 where the first row of retaining features includes apertures 118. However, the first and second row of slots 320, 330 can extend far enough into the body 314 to accommodate multiple axially aligned pins within the same slot (e.g., each slot can include 3-6 contact pins. As shown in FIG. 9, an embodiment of an alignment comb 408 includes apertures 418, which can have a wider diameter than apertures 118 to accommodate a plurality of diameters of pins of the same connector. Slots 420 can include tongues 432 to form slots 430 within slots 420. Here, slots 420 can accommodate pins from rows that are axially aligned and offset from one another and pins of different diameters within the same slot.

Embodiments provide an alignment comb designed to sit up higher on the board, and allow for better conformal coating coverage and inspection. The curved finger portions allow the comb to sit higher above the board, instead of laying flat on the board. This allows for better coating coverage and inspection of the solder joints, even without having to lift the comb manually. But further, because embodiments employ slots instead of apertures alone, the comb is able to be manually lifted higher than if the comb used only apertures to secure the pins. While the upper contact (first row) pass through through-holes (apertures) in the comb, the lower contacts (second and third rows) are instead bracketed on both sides by the finger portions of the comb, e.g., in the respective slots, preventing rotation. Accordingly, in embodiments, the comb height is no longer limited by the corner of the lowest contact (e.g., the contact pins of the second row). Embodiments may have more complex comb geometries, wherein the slots bracket multiple rows of contacts, allowing the comb to sit even higher, limited only by the corner of the highest contact (e.g., the contact pins of the first row). Embodiments of the alignment comb disclosed herein prevents the contact pins (e.g., solder tails) from rotating side to side during installation and soldering, allows the comb to sit higher on the tails and allows for adequate coating coverage and proper inspection of the solder joints once the pins are soldered to the board.

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the apparatus and methods of the subject disclosure have been shown and described, those skilled in the art will readily appreciate that changes and/or modifications may be made thereto without departing from the scope of the subject disclosure.

What is claimed is:

1. A system, comprising:
an alignment comb configured to prevent rotation of a contact pin of a connector relative to the connector, wherein the alignment comb includes:
a planar portion extending along a longitudinal axis between a first end and a second end;
an aperture defined in the planar portion; and
a slot defined at least partially within the planar portion, wherein the slot is defined between a first finger and a second finger, wherein a first portion of each finger is co-planar with the planar portion and wherein a second portion of each finger is out of plane with the planar portion,
wherein the aperture is configured to receive a first respective contact pin therein to retain the first respective contact pin within the aperture and wherein the slot is configured to receive a second respective contact pin therein to retain the second respective contact pin within the slot, wherein the alignment comb is configured to slide along the first and second respective contact pins.

2. The system of claim 1, wherein the alignment comb further includes a plurality of apertures defined in the planar portion along the axial length of the alignment comb between the first end and the second end.

3. The system of claim 2, wherein the plurality of apertures form a first row of apertures defined in the planar portion, and wherein the plurality of apertures further includes a second row of apertures.

4. The system of claim 2, wherein the alignment comb further comprises a plurality of slots defined in the alignment comb between respective fingers at least partially in the planar portion.

5. The system of claim 4, wherein the plurality of slots includes a first group of slots and a second group of slots, wherein the second group of slots extend farther into the planar portion than the first group of slots.

6. The system of claim 1, further comprising, the connector, wherein the connector includes the first respective contact pin and the second respective contact pin, wherein each of the first and second contact pins extend outward from a body of the connector in a first direction to a corner and extend from the corner downward in a second direction perpendicular to the first direction to a free end wherein the free end of the first respective contact pin is disposed in the aperture, and wherein the free end of the second respective contact pin is disposed in the slot.

7. The system of claim 6, wherein the alignment comb further includes a plurality of apertures defined in the planar portion along the axial length of the alignment comb between the first end and the second end of the alignment comb, and wherein the alignment comb further includes a plurality of slots defined between respective fingers,
wherein the connector includes a plurality of contact pins, extending from the body of the connector, wherein the first respective contact pin is defined in a first row of contact pins, wherein the second respective contact pin is defined in a second row of contact pins, aligned with the first row of contact pins, wherein the free end of each contact pin of the first row of contact pins is disposed in a respective aperture of the plurality of apertures and wherein the free end of each contact pin of the second row of contact pins is disposed in a respective slot of the plurality of slots.

8. The system of claim 7, wherein the plurality of contact pins further includes a third row of contact pins, wherein the third row of contact pins is between the first row of contact pins and the second row of contact pins, wherein the plurality of apertures further includes a second row of apertures defined in the planar portion along the axial length of the alignment comb between the first end and the second end, wherein the free end of each contact pin of the third row of contact pins is disposed in a respective aperture of the second row of apertures.

9. The system of claim 8, wherein the alignment comb is configured to slide along the contact pins up to the corner of the third row of contact pins, wherein the corner of the third row of contact pins is higher than the corner of the second row of contact pins to allow for application of a conformal coating on the contact pins and/or to allow soldering the contact pins to a printed wiring board.

10. The system of claim 7, wherein the plurality of contact pins further includes a third row of contact pins, wherein the third row of contact pins is between the first row of contact pins and the second row of contact pins, wherein the plurality of slots includes a first group of slots and a second group of slots, wherein the second group of slots extend farther into the planar portion than the first group of slots, wherein the free end of each contact pin of the third row of contact pins is disposed in a respective slot of the second row of slots.

11. The system of claim 10, wherein the alignment comb is configured to slide along the contact pins up to the corner of the first row of contact pins, wherein the corner of the first row of contact pins is higher than the corner of the third row of contact pins to allow for application of a conformal coating on the contact pins and/or to allow soldering the contact pins to a printed wiring board.

12. The system of claim 1, wherein the alignment comb is of a non-electrically conductive material.

13. A system, comprising:
a printed wiring board;
a connector having a plurality of contact pins configured to be soldered to the printed wiring board, wherein the plurality of contact pins include:
a first row of contact pins;
a second row of contact pins; and
a third row of contact pins,
wherein each contact pin of the first row, the second row, and the third row,
extends outward from a body of the connector in a first direction to a corner portion and extends away from the corner in a second direction perpendicular to the first direction to a free end of the contact pin, wherein the contact pins of the first row are longer than the contact pins of the second row, and wherein the contact pins of the third row are longer than the contact pins of the second row and shorter than the contact pins of the first row; and
an alignment comb configured to prevent rotation of the free end of the contact pin relative to the connector, wherein the alignment comb includes:
a first row of retaining features configured to retain the contact pins of the first row;
a second row of retaining features configured to retain the contact pins of the second row; and
a third row of retaining features configured to retain the third row of contact pins,
wherein the first row of retaining features includes a plurality of apertures,
wherein each contact pin of the first row of contact pins is disposed in a respective aperture of the plurality of apertures, wherein the second row of retaining features includes a plurality of slots defined between a first finger and a second finger, wherein each contact pin of the second row of contact pins is disposed in a respective each slot of the plurality of slots, wherein each contact pin of the third row is disposed a respective retaining feature of the third row of retaining features.

14. The system of claim 13, wherein the third row of retaining features includes a plurality of apertures defining a second row of apertures, wherein each contact pin of the third row of contact pins is disposed in a respective aperture of the second row of apertures.

15. The system of claim 13, wherein the third row of retaining features includes a plurality of slots defined between respective fingers of a plurality of fingers, and wherein the plurality of slots includes a first group of slots and a second group of slots, wherein the second group of slots extend farther into a body of the alignment comb than the first group of slots.

16. The system of claim 15, wherein a first portion of each finger is co-planar with the body of the alignment comb and wherein a second portion of each finger is out of plane with the body of the alignment comb.

17. The system of claim 13, wherein the alignment comb is of a non-electrically conductive material.
